(19) United States
(12) Patent Application Publication
(10) Pub. No.: US 2018/0151998 A1
(43) Pub. Date: May 31, 2018

(54) STEPPED-CLADDING FIBER-LINK FOR HIGH DENSITY FIBER COMBINERS

(71) Applicant: BAE Systems Information and Electronic Systems Integration Inc., Nashua, NH (US)

(72) Inventors: Benjamin R. Johnson, Nottingham, NH (US); Daniel J. Creeden, Bloomfield, CT (US)

(73) Assignee: BAE Systems Information And Electronic Systems Integration Inc.

(21) Appl. No.: 15/825,859

(22) Filed: Nov. 29, 2017

Related U.S. Application Data
(60) Provisional application No. 62/427,400, filed on Nov. 29, 2016.

(51) Int. Cl. H01S 3/067; H01S 3/094

(52) U.S. Cl. CPC H01S 3/06745; H01S 3/094053; H01S 3/094042

(57) ABSTRACT

A fiber optic cable including a first end and a second end, a core adapted to receive and transmit an optical signal and a cladding layer surrounding the core is disclosed. The fiber optic cable may include a ratio of an outside diameter of the cladding layer to a diameter of the core that decreases from the first end to the second end while the diameter of the core remains substantially uniform. The fiber optic cable may include a first portion of the cladding layer and a second portion of the cladding layer. A uniform outside diameter of the second portion may be less than a uniform outside diameter of the first portion. The fiber optic cable may further include a third portion of the cladding layer. A uniform outside diameter of the third portion may be less than a uniform outside diameter of the second portion.

### CROSS REFERENCE TO RELATED APPLICATIONS

This application claims the benefit of U.S. Provisional Application Ser. No. 62/427,400, filed on Nov. 29, 2016; the disclosure of which is incorporated herein by reference.

### BACKGROUND

### Technical Field

The present disclosure relates to systems and methods for constructing fiber lasers to increase the core fiber brightness efficiency into fiber combiners. More particularly, the present disclosure relates to enhancing effective core fiber brightness by reducing a clad to core ratio and minimizing loss for tandem-pumping of fiber lasers. Specifically, the present disclosure relates to enhancing effective core fiber brightness by reducing a clad to core ratio and minimizing loss for tandem-pumping of fiber lasers accomplished with a stepped cladding fiber link construction technique.

### Background Information

Multi-clad fiber lasers convert low-brightness pump light, typically from a diode laser, into high-brightness signal light in a rare-earth-doped core using a low brightness ratio fused-fiber combiner. Generally, tandem pumping is when one (or more) fiber lasers are used to pump another fiber laser/amplifier. High brightness ratio fused-fiber combiners are needed to combine the core of high brightness fiber lasers into the low brightness cladding of another fiber laser/amplifier. The packing efficiency of high brightness ratio combiners is predominantly limited by ratio of the input fiber core/cladding dimensions of the input fibers.

For ease of reference, the size of optical fibers described herein may be commonly referred to by the outer diameter of its core, cladding and coating. For example, an optical fiber denoted as 16/242/400 represents an optical fiber with a core having an outer diameter of 16 microns (μm), cladding having an outer diameter of 242 μm and a coating having an outer diameter of 400 μm. As another example, an optical fiber denoted as 16/242 represents an optical fiber with a core having an outer diameter of 16 μm and cladding having an outer diameter of 242 μm with no coating.

Conventional fibers for the combiner tend to have either uniform or tapered dimensions. Consider one example of a multi-mode combiner with 7 inputs and 1 output. The input fibers have a diameter that measures 105/125 μm with a numerical aperture (NA) of 0.22. These are to be combined into another multi-mode fiber with a 220 μm, 0.44 NA core. A taper ratio of two on the input fibers yields dimensions of 52.5/62.5 μm, 0.44 NA. The tapered fiber decreases the initial required receiving fiber dimensions from 375 μm (3×125 μm) to 187.5 μm (3×62.5 μm). This type of combiner has a low brightness ratio because the input and output fibers are similar in brightness (i.e. core diameter, NA).

Generally, tandem pumping requires high brightness ratio combiners to exploit the benefits of fiber lasers. Consider seven input fibers of 25/250 μm, 0.1 NA combined into a 220 μm, 0.44 NA μm fiber. The NA of the input fiber core allows for a taper ratio of at least four. This yields tapered fiber dimensions of 6.25/62.5 μm, 0.40 NA.

### SUMMARY

In one aspect, the present disclosure may provide a fiber optic cable including a first end and a second end, a core adapted to receive and transmit an optical signal and a cladding layer surrounding the core. The fiber optic cable may further include a ratio of an outside diameter of the cladding layer to a diameter of the core that decreases from the first end to the second end while the diameter of the core remains substantially uniform.

The fiber optic cable may further include a first portion of the cladding layer and a second portion of the cladding layer. A uniform outside diameter of the second portion may be less than a uniform outside diameter of the first portion. Further, a ratio of the uniform outside diameter of the first portion to the uniform outside diameter of the second portion may be at most approximately 2:1.

The fiber optic cable may further include a first end wall and a second end wall of the first portion of the cladding layer and a first end wall and a second end wall of the second portion of the cladding layer. The fiber optic cable may further include an exposed area of the second end wall of the first portion of the cladding layer formed when the second end wall of the first portion of the cladding layer is connected to the first end wall of the second portion of the cladding layer. The second end wall of the first portion of the cladding layer may be connected to the first end wall of the second portion of the cladding layer by splicing.

The fiber optic cable may further include a third portion of the cladding layer. A uniform outside diameter of the third portion may be less than a uniform outside diameter of the second portion. A ratio of the uniform outside diameter of the second portion to the uniform outside diameter of the third portion may be at most approximately 2:1.

The fiber optic cable may further include a first end wall and a second end wall of the third portion of the cladding layer and an exposed area of the second end wall of the second portion of the cladding layer formed when the second end wall of the second portion of the cladding layer is connected to the first end wall of the third portion of the cladding layer. The second end wall of the second portion of the cladding layer may be connected to the first end wall of the third portion of the cladding layer by splicing.

The fiber optic cable may be connected to a high-density tapered fiber bundle, a triple clad fiber, at least one input fiber laser, at least one seed laser, at least one thulium-doped amplifier, an output laser source and a thulium/holmium-doped amplifier.

In another aspect, the present disclosure may provide a first cladded optical fiber including a uniform first outer diameter along its length connected to a pump laser and a second cladded optical fiber including a uniform second outer diameter along its length connected to the first cladded optical fiber so as to allow an optical signal to move from the first cladded optical fiber through the second cladded optical fiber. The uniform second outer diameter may be less than the uniform first outer diameter. The fiber laser may further include a third cladded optical fiber including a uniform third outer diameter along its length connected to the second cladded optical fiber. The uniform third outer diameter may be less than the uniform second outer diameter.

The fiber laser may further include a first core diameter of the first cladded optical fiber, a second core diameter of the second cladded optical fiber and a third core diameter of the third cladded optical fiber. The first core diameter, the second core diameter and the third core diameter may be substantially equal.

The fiber laser may further include a fourth cladded optical fiber including a distal end coupled to a combiner having a decreasing tapered outer cladding diameter and a decreasing tapered core diameter. The fiber laser may further include a length of each of the cladded optical fibers. Each length of each of the cladded optical fibers may be substantially equivalent. The fiber laser may further include a high-density tapered fiber bundle, a triple clad fiber, at least one input fiber laser, at least one seed laser, at least one thulium-doped amplifier, an output laser source and a thulium/holmium-doped amplifier.

In another aspect, the present disclosure may provide a method for optical fiber transmission comprising generating an optical signal from a pump source. The method may further include connecting the pump source to one end of a first uniform diameter cladded optical fiber and connecting another end of the first uniform diameter cladded optical fiber to one end of a second uniform diameter cladded optical fiber. A cladding diameter of the second uniform diameter cladded optical fiber may be less than a cladding diameter of the first uniform diameter cladded optical fiber. A core diameter of the first uniform diameter cladded optical fiber and a core diameter of the second uniform diameter cladded optical fiber may remain uniform. The method may further include coupling the optical signal from the pump source through the first and second uniform diameter cladded optical fibers and coupling the optical signal to a combiner.

The connecting another end of the first uniform diameter cladded optical fiber to one end of a second uniform diameter cladded optical fiber may be accomplished by splicing. The splicing of the first uniform diameter cladded optical fiber to one end of a second uniform diameter cladded optical fiber may be accomplished by aligning core fiber elements as a primary alignment.

The method may further include connecting another end of the second uniform diameter cladded optical fiber to a plurality of tapered optical fibers. The connecting another end of the second uniform diameter cladded optical fiber to a plurality of tapered optical fibers may be accomplished by splicing. The splicing of the second uniform diameter cladded optical fiber to a plurality of tapered optical fibers may be accomplished by aligning core fiber elements as a primary alignment.

The method may further include connecting at least one intermediate uniform diameter cladded optical fiber between the first and second uniform diameter cladded optical fibers. Each cladding diameter of the first, intermediate and second uniform diameter cladded optical fibers decreases from the first uniform diameter cladded optical fiber to the second uniform diameter cladded optical fiber.

The method may further include connecting another end of the second uniform diameter cladded optical fiber to one end of a high-density tapered fiber bundle and connecting another end of the high density tapered fiber bundle to a triple clad fiber. The method may further include connecting another end of the triple clad fiber to the combiner.

In another aspect, the present disclosure may provide a fiber optic cable including a first end and a second end, a core adapted to receive and transmit an optical signal and a cladding layer surrounding the core. The fiber optic cable may include a ratio of an outside diameter of the cladding layer to a diameter of the core that decreases from the first end to the second end while the diameter of the core remains substantially uniform. The fiber optic cable may include a first portion of the cladding layer and a second portion of the cladding layer. A uniform outside diameter of the second portion may be less than a uniform outside diameter of the first portion. The fiber optic cable may further include a third portion of the cladding layer. A uniform outside diameter of the third portion may be less than a uniform outside diameter of the second portion.

In another aspect, the present disclosure may provide systems and methods which include techniques and architecture for a series of treatments or manipulations of the cladding of an optical fiber, or fibers, such that the cladding geometry decreases in size while the properties of the core are identical. The systems and methods may mitigate geometrical limitations placed on typical fused-fiber combiners by the cladding dimensions of the input fibers. Decreasing the size of the input fiber cladding may increase the packing-efficiency of fused-fiber combiners. The systems and methods may apply to both pump and signal inputs to a pump combiner.

### BRIEF DESCRIPTION OF THE SEVERAL VIEWS OF THE DRAWINGS

Sample embodiments of the present disclosure are set forth in the following description, is shown in the drawings and is particularly and distinctly pointed out and set forth in the appended claims.

FIG. 1A is a sectional view of a PRIOR ART uniform diameter cladded optical fiber;

FIG. 1B is a sectional view of a PRIOR ART tapered diameter cladded optical fiber;

FIG. 2A is an end view of several PRIOR ART uniform diameter cladded optical fibers;

FIG. 2B is an end view of several PRIOR ART tapered diameter cladded optical fibers;

FIG. 3A is a partial sectional view of a stepped cladded optical fiber according to one embodiment of the present disclosure;

FIG. 3B is a partial sectional view of a stepped cladded optical fiber showing end taper according to one embodiment of the present disclosure;

FIG. 4 is an end view of several stepped cladded optical fibers according to one embodiment of the present disclosure;

FIG. 5 is a diagram of a system using tapered diameter cladded optical fiber according to one embodiment of the present disclosure;

FIG. 6 is a diagram of a system in accordance with one aspect of the present disclosure with background fibers omitted;

FIG. 7 is a cross-section of seven input fibers of 16/242/400, 0.09 NA showing an acrylate coating, a fiber cladding and a fiber core;

FIG. 8 is a cross-section of the seven fibers of 20/130/250, 0.1 NA showing the acrylate coating, the fiber cladding and the fiber core;

FIG. 9 is a cross-section of seven fibers of 20/80/250, 0.1 NA showing a capillary tube, the acrylate coating, the fiber cladding and the fiber core;

FIG. 10 is a cross-section of seven fibers of 20/80, 0.1 NA showing the fiber cladding and the fiber core;

FIG. 11 is a cross-section of seven fibers of 10/40, 0.1 NA showing the fiber cladding and the fiber core;

FIG. 12 is a diagram of a system 1200 in accordance with one aspect of the present disclosure;

FIG. 12A is a diagram of a system 1200 in accordance with one aspect of the present disclosure connected to an input fiber laser, a seed laser, a high-density tapered fiber bundle, a thulium-doped amplifier, an output laser source and a thulium/holmium-doped amplifier;

FIG. 13 is a graph depicting test results for a one hundred watt two micron fiber laser in accordance with one aspect of the present disclosure;

FIG. 14 is a diagram of a system in accordance with one aspect of the present disclosure; and

FIG. 15 is a graph depicting a Gaussian beam profile representing mode field diameters for three fiber lasers.

Similar numbers refer to similar parts throughout the drawings.

### DETAILED DESCRIPTION

This disclosure relates to a series of stepped cladding of an optical fiber, or fibers, such that the uniform cladding geometry decreases in size per section of fiber while the properties of the core are substantially identical. The disclosed system mitigates geometrical limitations placed on typical tapered fused-fiber combiners by the cladding dimensions of the input fibers. Decreasing the size of the input fiber cladding ultimately increases packing-efficiency of fused-fiber combiners. This method applies to both pump and signal inputs to a pump combiner.

High power fiber lasers are enabled by fused fiber combiners wherein they inject pump, or signal and pump from multiple fibers into a single fiber. Fused-fiber combiners can handle several kilowatts (kW) of optical power. Regardless of power handling, every combiner must obey brightness conservation. Typical fiber combiners use a tapering method to combine multiple fibers into a single output fiber. Conservation of brightness limits the taper ratio of the input fibers to the output fiber. This taper ratio defines the number of fibers efficiently combined to a single fiber. The present system increases the packing efficiency of fused-fiber combiners beyond simple tapering of the fiber.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

High power laser diodes have become a staple pump source for both solid state and fiber optic lasers due to their high brightness, spectral versatility, environmental robustness and high efficiency. Typical high power fiber coupled diode lasers are focused into the large core of a glass-cladded multimode fiber.

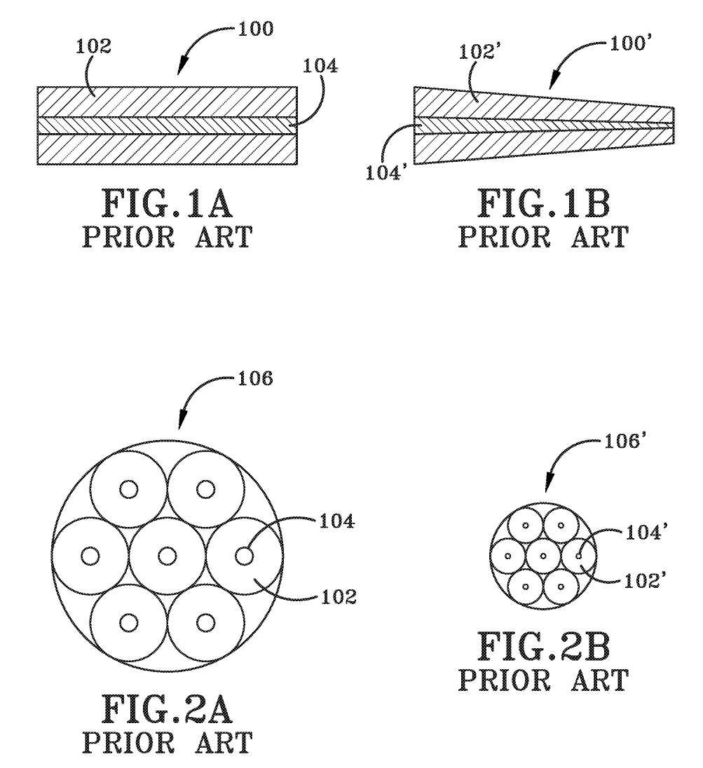

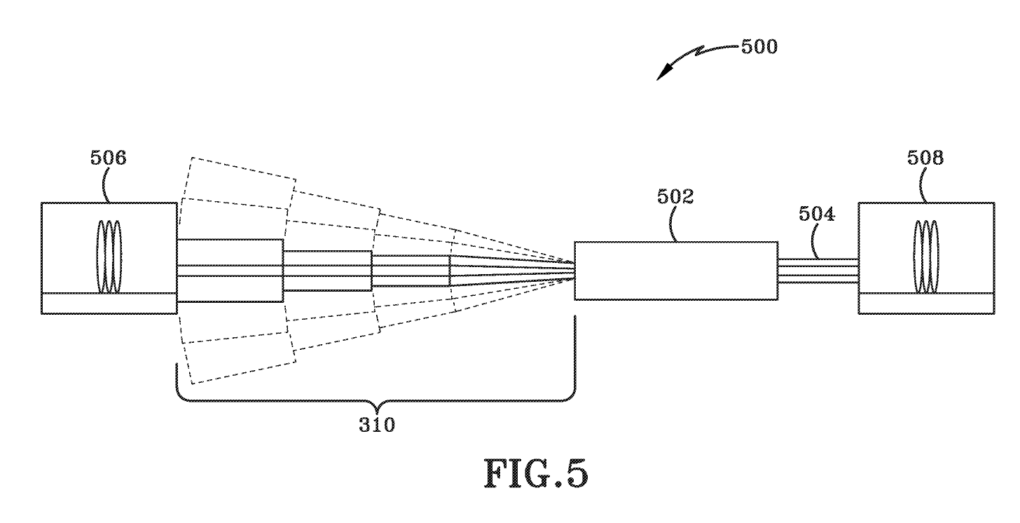

FIG. 1A is a sectional view of a PRIOR ART uniform diameter cladded optical fiber 100, having cladding 102 surrounding optical fiber 104. FIG. 1B is a sectional view of the uniform diameter cladded optical fiber of FIG. 1A having been tapered in diameter to allow denser packing of tapered cladded optical fibers 100′ entering into a fused-fiber combiner 202 (FIG. 5). The process of tapering an optical fiber is well known in the art. During the process of tapering, the cladding 102 and optical fiber 104 decrease in size as a constant proportion as the glass is drawn out. This is depicted in FIG. 1B as cladding 102′ and optical fiber 104′ of tapered cladded optical fibers 100′ decrease in overall diameter.

FIG. 2A and FIG. 2B are end views 106, 106′ of several of uniform diameter cladded optical fibers 100 and tapered cladded optical fibers 100′ respectively prior to entering a fused-fiber combiner 202 (FIG. 5). While the tapered nature of these prior art embodiments result in a higher quantity of optical fibers entering a fused-fiber combiner 202 (FIG. 5) than uniform diameter cladded optical fibers 100, the process of tapering does not increase the total amount of light entering into the combiner as the brightness of the fibers is limited by the decreased diameter of the optical fiber 104′. The ratio of cladding to core fiber in this PRIOR ART embodiment does not increase the optical brightness as compared to the original uniform diameter cladded optical fibers 100.

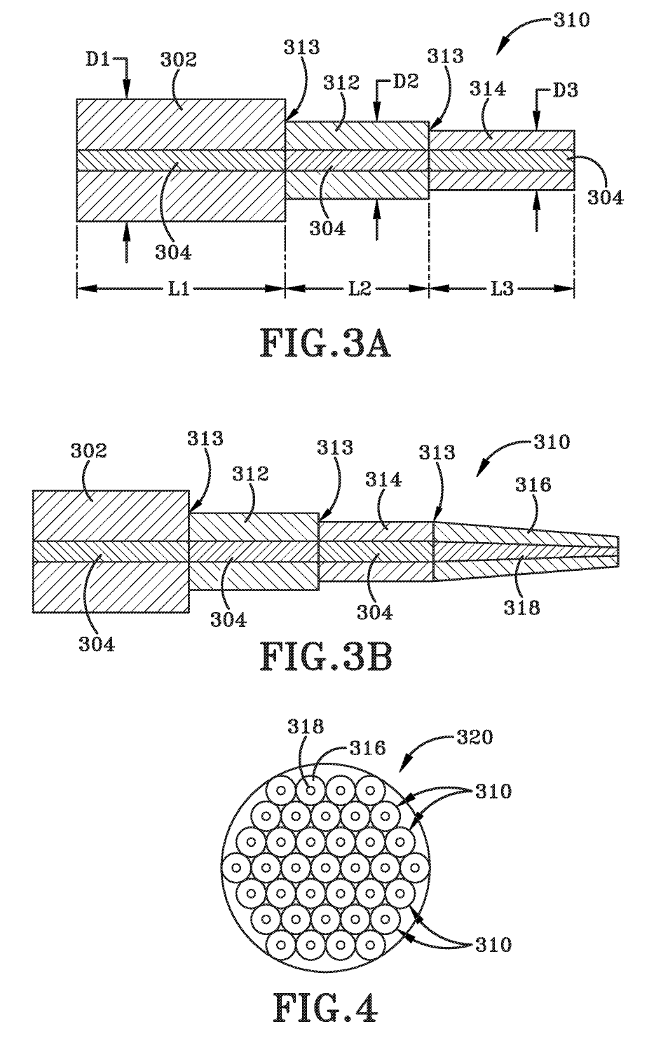

FIG. 3A and related FIG. 3B are sectional views of one embodiment of a system 300 in accordance with one aspect of the present disclosure. The system 300 includes stepped cladding 302, 312 and 314 of stepped cladded optical fibers 310 that are distinct strings of fibers spliced 313 together using processes well known in the art, while the properties of the core fiber are substantially the same. It is incumbent that the splicing of fibers with different cladding diameters has the alignment of the core fiber as the main objective of the joining to reduce the geometric coupling loss due to misaligned core fibers.

Uniform stepped cladding 302 has a uniform diameter D1 along its length L1. Uniform stepped cladding 312 has a uniform diameter D2 along its length L2, and uniform stepped cladding 314 has a uniform diameter D3 along its length L3. In one example the lengths L1, L2, and L3 are the same while in another example the lengths L1, L2, and L3 are different.

There may be multiple sections of the uniform stepped cladding according to desired design requirements. The dimensional change from one section to another (e.g. D1 to D2) in one example is a consistent change across the various sections either by a fixed dimension or as a percentage reduction. In another example, the dimensional change from one section to another (e.g. D1 to D2) is not consistent. It should be noted that FIG. 1A-FIG. 3B as represented herein are not drawn to scale, but enlarged to show relative sizing of the cladding and the core.

For example, the largest fiber 302 may be a 25/250 μm (core fiber diameter/cladding diameter) with the next fiber 312 being 25/125 μm, and next splice fiber 314 being 25/80 μm. As can be seen in FIG. 3A and FIG. 3B, the core diameter 304 is consistent throughout these splices 313 as the cladding diameter is reduced. FIG. 3B shows the tapering of the last fiber segment 316 and core fiber 318 that allows for a much higher density cross-section of active fibers being packed into a fused-fiber combiner 502 (FIG. 5).

FIG. 4 is an end view 320 of several of stepped diameter cladding optical fibers 310 with exposed tapered optical fiber 316 and core fiber 318 prior to entering a fused-fiber combiner 502 (FIG. 5) showing a higher density of fibers, with a higher density of larger diameter core fiber 318 due to the use of stepped cladded fibers.

FIG. 5 is a diagram of a system 500 comprising the combining of signal or pump energy into a laser using a fused-fiber combiner. The fiber optic string 310 couples a pump source 506 to a pump combiner 502 with the output of pump combiner 502 being fed into a single output fiber 504 for use in a pumped laser/amplifier 508. The fiber optic string 310 is comprised of multiple sections of stepped cladded optical fiber sections, each section having a uniform core diameter and wherein the cladding diameter decreases in each section from the pump source 506.

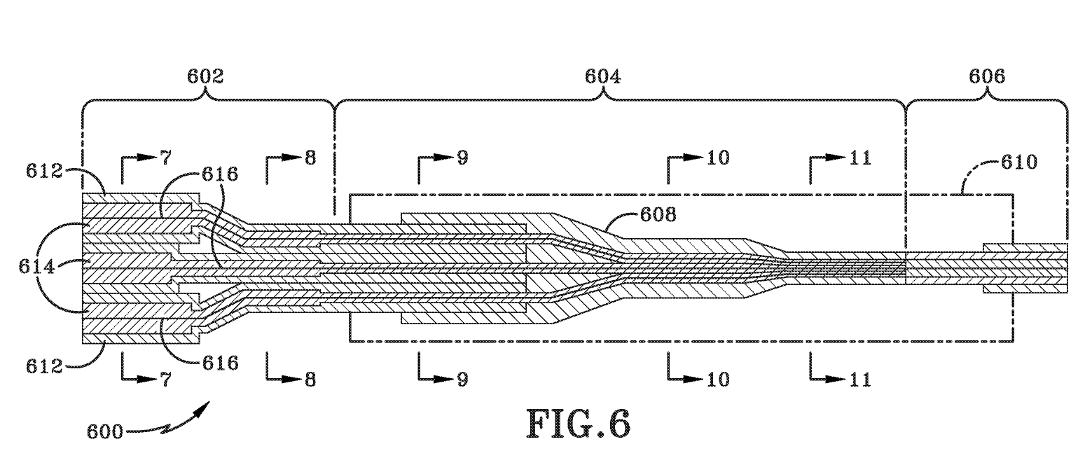

FIG. 6 is a diagram of a system 600 in accordance with one aspect of the present disclosure with background fibers omitted for ease of reference. In one example, system 600 may be a pump source beam combiner, or a multiple fiber combiner, such as a 7×1, which is a multiple fiber combiner having seven multimode fibers combined into one output fiber.

System 600 may comprise stepped cladding fiber links 602, a high-density tapered fiber bundle 604, a triple clad fiber 606, a capillary tube 608 and a mechanical housing 610. The stepped cladding fiber links 602 may include an acrylate coating 612, a fiber cladding 614 and a fiber core 616.

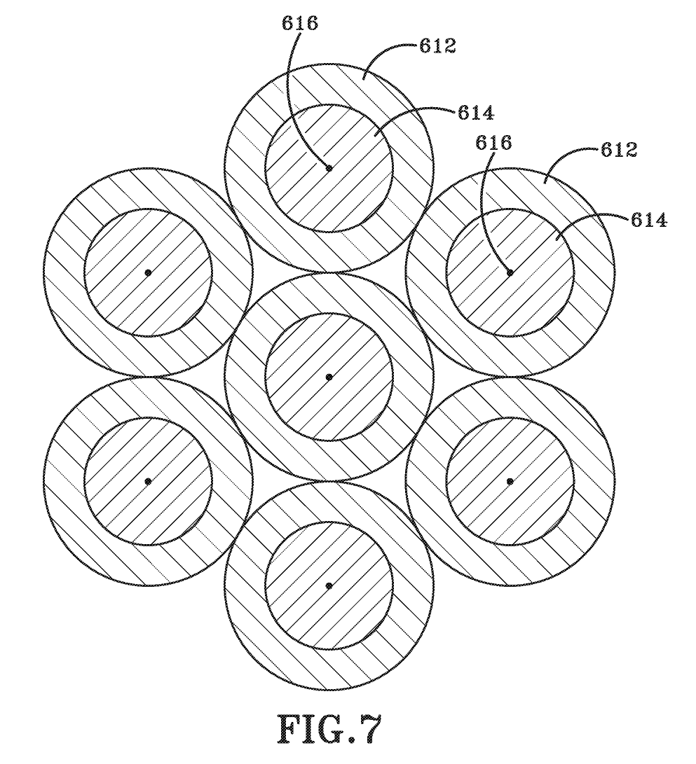

In one example, the stepped cladding fiber links 602 may be seven input fibers of 16/242/400 (i.e. core outer diameter/cladding outer diameter/acrylate coating outer diameter), 0.09 NA on one end. FIG. 7 is a cross-section of the seven input fibers of 16/242/400, 0.09 NA showing the acrylate coating 612, the fiber cladding 614 and the fiber core 616.

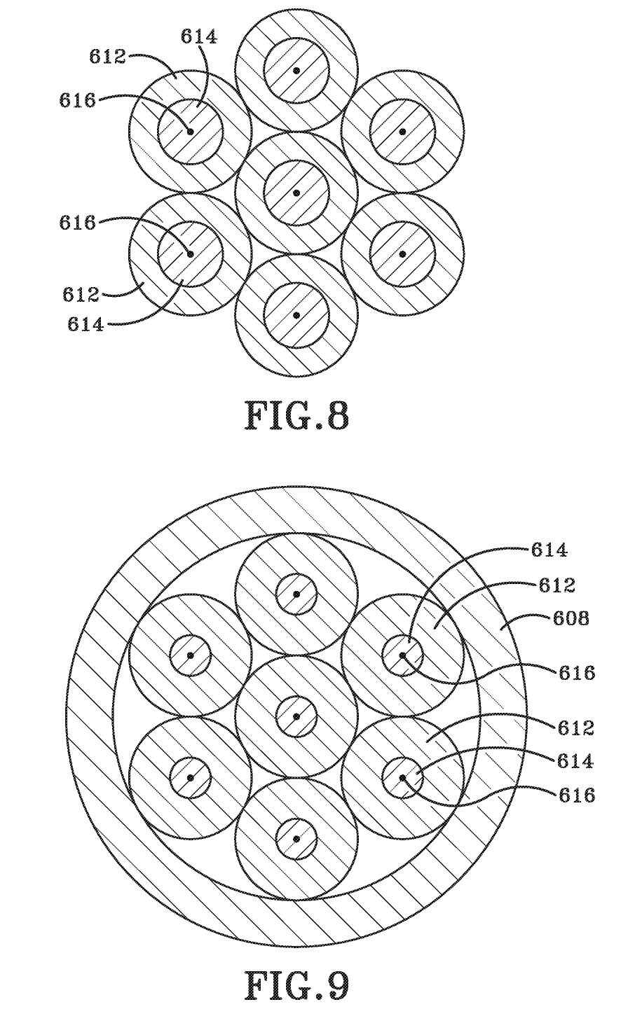

The seven input fibers of 16/242/400, 0.9 NA may be combined, by splicing, with seven fibers of 20/130/250, 0.1 NA. FIG. 8 is a cross-section of the seven fibers of 20/130/250, 0.1 NA showing the acrylate coating 612, the fiber cladding 614 and the fiber core 616.

The stepped cladding fiber links 602 are combined with the high density tapered fiber bundle 604. The seven fibers of 20/130/250, 0.1 NA are combined, by splicing, with seven fibers of 20/80/250, 0.1 NA. FIG. 9 is a cross-section of the seven fibers of 20/80/250, 0.1 NA showing the capillary tube 608, the acrylate coating 612, the fiber cladding 614 and the fiber core 616. After splicing with the seven fibers of 20/80/250, 0.1 NA, the fiber core 616 is still 20 microns; however, the outer diameter of the cladding 614 has been reduced from 242 microns to 80 microns.

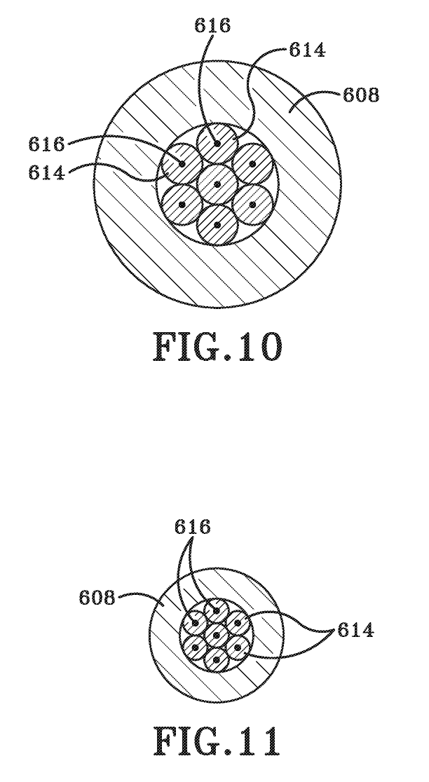

The seven fibers of 20/80/250, 0.1 NA are down-tapered to seven fibers of 20/80 (i.e. core outer diameter/cladding outer diameter), 0.1 NA by removing the acrylate coating 612 and collapsing the fibers down the capillary tube 608. FIG. 10 is a cross-section of the seven fibers of 20/80, 0.1 NA showing the fiber cladding 614 and the fiber core 616. The taper ratio for this combination is 1.5:1.

The seven fibers of 20/80, 0.1 NA may be down-tapered to seven fibers of 10/40, 0.1 NA. FIG. 11 is a cross-section of the seven fibers of 10/40, 0.1 NA showing the fiber cladding 614 and the fiber core 616. The taper ratio for this combination is 2:1 and the seven fibers of 10/40, 0.1 NA are approximately 125 microns in diameter. Therefore, the process allows seven input lasers to be positioned within a cladding that is smaller in diameter than any cladding size of any individual input laser of the system 600.

The stepped cladding fiber links 602 decrease the pitch of packed cores artificially spoiled by large fiber claddings. The sequential step-down of cladding dimensions in the stepped cladding fiber links 602 via splicing is efficient, reliable and repeatable. Further, the sequential step-down of cladding dimensions in the stepped cladding fiber links 602 distributes brightness loss over several splices rather than in the fiber bundle. In one example, it is important to model fiber prescriptions to manage splice loss at each interface, minimize power loss in the high density tapered fiber bundle to higher-order mode (HOM) content, provide packing/tapering margin for power scaling and remain flexible to various fiber-based pump source geometries.

It is to be understood that the number of input fibers may be any suitable number of input fibers and the input fibers may further be any suitable core fiber diameter/cladding diameter/acrylate coating diameter configuration.

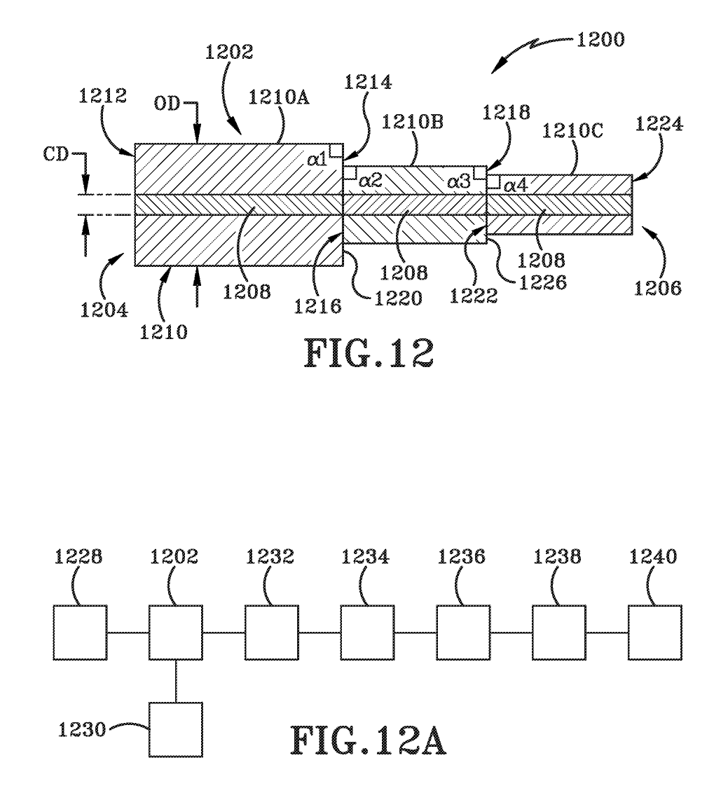

FIG. 12 is a diagram of a system 1200 in accordance with one aspect of the present disclosure. In one example, system 1200 may be a fiber optic cable 1202 including a first end 1204 and a second end 1206. The fiber optic cable 1202 may include a core 1208 adapted to receive and transmit an optical signal (not shown). The fiber optic cable 1202 may include a cladding layer 1210 surrounding the core 1208. The fiber optic cable 1202 may include a ratio of an outside diameter OD of the cladding layer 1210 to a core diameter CD that decreases from the first end 1204 to the second end 1206. The core diameter CD may remain substantially uniform or identical.

The cladding layer 1210 may further include a first portion 1210A and a second portion 1210B. The first portion 1210A may include a uniform outside diameter OD1 and the second portion 1210B may include a uniform outside diameter OD2. The uniform outside diameter OD2 of the second portion 1210B may be less than the uniform outside diameter OD1 of the first portion 1210A. In one example, a ratio of the uniform outside diameter OD1 of the first portion 1210A to the uniform outside diameter OD2 of the second portion 1210B may be at most approximately 2:1; however, it is envisioned that other suitable ratios may be utilized.

The first portion 1210A of the cladding layer 1210 may include a first end wall 1212 and a second end wall 1214. The second portion 1210B of the cladding layer 1210 may include a first end wall 1216 and a second end wall 1218. The second end wall 1214 of the first portion 1210A of the cladding layer 1210 may include an exposed area 1220 formed when the second end wall 1214 of the first portion 1210A of the cladding layer 1210 is connected to the first end wall 1216 of the second portion 1210B of the cladding layer 1210. As shown in FIG. 12, and in one example, the exposed area 1220 may be vertical when viewed in vertically longitudinal cross-section and may define a first angle α1 and a second angle α2. In one example, the first angle α1 may be 90 degrees and the second angle α2 may be 90 degrees; however, the first angle α1 and the second angle α2 may be any suitable angles. In one example, the second end wall 1214 of the first portion 1210A of the cladding layer 1210 may be connected to the first end wall 1216 of the second portion 1210B of the cladding layer 1210 by splicing.

As shown in FIG. 12, the cladding layer 1210 may further include a third portion 1210C. The third portion 1210C may include a uniform outside diameter OD3. The uniform outside diameter OD3 of the third portion 1210C may be less than the uniform outside diameter OD2 of the second portion 1210B. In one example, a ratio of the uniform outside diameter OD2 of the second portion 1210B to the uniform outside diameter OD3 of the third portion 1210C may be at most approximately 2:1; however, it is envisioned that other suitable ratios may be utilized.

The third portion 1210C of the cladding layer 1210 may include a first end wall 1222 and a second end wall 1224. The second end wall 1218 of the second portion 1210B of the cladding layer 1210 may include an exposed area 1226 formed when the second end wall 1218 of the second portion 1210B of the cladding layer 1210 is connected to the first end wall 1222 of the third portion 1210C of the cladding layer 1210. As shown in FIG. 12, and in one example, the exposed area 1226 may be vertical when viewed in vertically longitudinal cross-section and may define a third angle α3 and a fourth angle α4. In one example, the third angle α3 may be 90 degrees and the fourth angle α4 may be 90 degrees; however, the third angle α3 and the fourth angle α4 may be any suitable angles. In one example, the second end wall 1218 of the second portion 1210B of the cladding layer 1210 may be connected to the first end wall 1222 of the third portion 1210C of the cladding layer 1210 by splicing.

As shown in FIG. 12A, and in one example, the fiber optic cable 1202 may be connected to at least one input fiber laser 1228, at least one seed laser 1230, a high-density tapered fiber bundle 1232, a triple clad fiber 1234, at least one thulium-doped amplifier 1236, an output laser source 1238 and a thulium/holmium-doped amplifier 1240. It is envisioned that the fiber optic cable 1202 may be utilized with various architectures and is not limited to being utilized within the architecture shown in FIG. 12A.

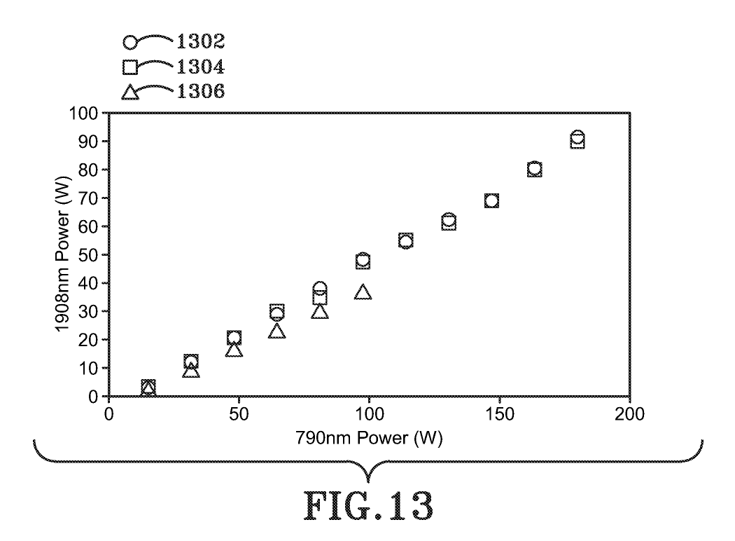

FIG. 13 is a graph depicting test results for a 100 watt 2 micron fiber laser. A 16/242 source laser is represented by a circle 1302, a 16/242 source laser spliced into a 20/130 fiber laser is represented by a square 1304 and a 16/242 source laser spliced into the 15/130 fiber laser is represented by a triangle 1306. As shown in FIG. 13, the 16/242 source laser was spliced into a 20/130 fiber laser with only an approximately one percent loss. In one example, the 20/130 fiber may then be spliced in accordance with the teachings of the present disclosure into a 20/80 fiber with similar conversion efficiency. Further, and as shown in FIG. 13, the 16/242 source laser was spliced into a 15/130 fiber laser with an approximately twenty percent loss. Thus, FIG. 13 illustrates the importance of selecting suitable tapering ratios and fiber geometries.

One of the reasons the splicing is done in multiple steps is based on the difference in cladding size between the fibers that are being spliced together. In one example, and generally, the larger the difference in the cladding diameters of the fibers being spliced together, the more difficult they are to splice together. This is based, at least in part, on the different amounts of material that need to be heated simultaneously during the splicing. Because the materials have the same melting points, it may be difficult to melt the larger fiber having more material without excessively melting the smaller fiber. Further, an unsuitable amount of loss is generally associated with splicing together fibers having large differences in cladding diameters compared to splicing together fibers having more similar cladding diameters. As stated above, one way to manage loss associated with splicing is to perform multiple steps of splicing and by splicing fibers of similar cladding diameters. In one example, suitable cladding ratios for dissimilar cladding splices may be 2:1; however, any other suitable cladding ratios for dissimilar cladding splices may be utilized.

In accordance with one aspect of the present disclosure, stepped cladding fiber links may be utilized with a tandem-resonated-pumped (TRP) fiber laser. A TRP is a laser source that distributes waste heat over multiple high efficiency pumps and amplifier stages. TRP fiber laser sources are not polarized (simplifies laser construction), need no phase or path length control (removes electronics complexity) and can be spectrally broad (avoids stimulated Brillouin scattering (SBS) limitations). Further, operating at 2 μm, instead of 1 μm, raises optical non-linearity and modal instability thresholds and provides a three times wider emission bandwidth (provided by thulium and holmium) which provides a path to source and combined laser powers higher than currently demonstrated in the art.

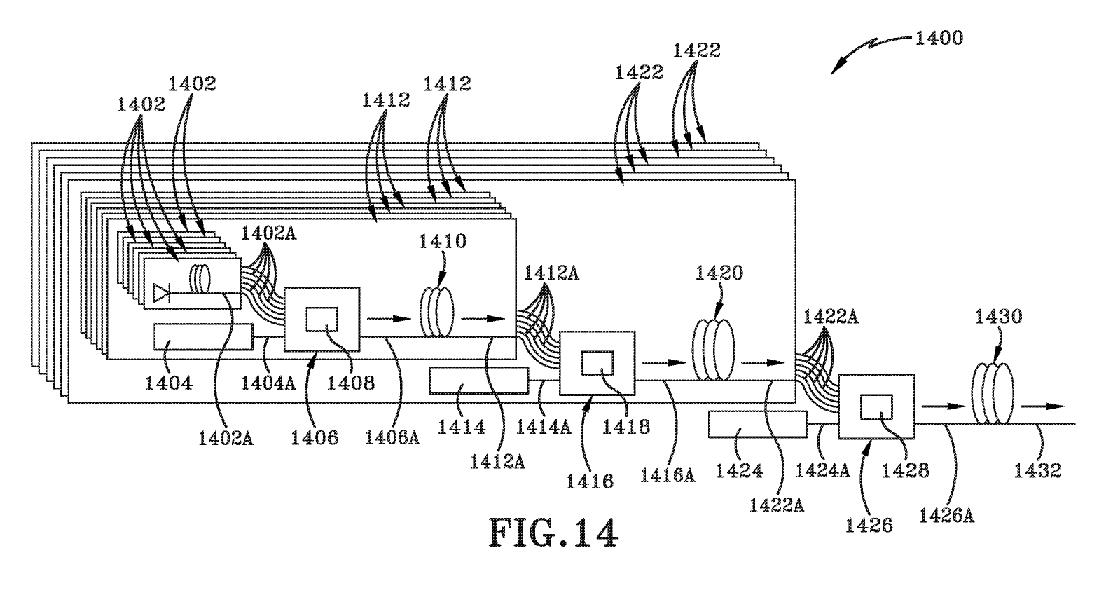

The cascaded combination of high power pump sources by TRP of fiber lasers and amplifiers, as shown in FIG. 14 and more fully described below, is an exemplary architecture showing advantages of operating at 2 μm instead of 1 μm. This recursive architecture uses several high power single mode fiber lasers to pump another fiber amplifier operating at a slightly longer wavelength (approximately in the range of 35-50 nm), at high efficiency (approximately in the range of 85%-90%), with the same brightness and near-diffraction limited beam quality as the pump sources themselves.

Several of these amplifiers can be used to pump another high efficiency, high brightness, near diffraction limited amplifier operating an additional approximately 50 nm longer. This cascaded combination of amplifiers using TRP of fiber amplifiers can be executed across the 300 nm bandwidth provided by both Tm-doped and Ho-doped gain mediums. Starting with 100 watt pump laser sources and three cascaded amplifier stages (i.e. 6 pumps/stage) operating at approximately 90% efficiency nearly 13 kW can potentially be generated at 2 μm with near diffraction-limited beam quality.

FIG. 14 is a diagram of a system 1400 in accordance with one aspect of the present disclosure. In one example, the system 1400 may be TRP fiber laser, which generally means that the pump wavelength and the signal wavelength are similar. In other words, the thulium-doped fiber amplifier is being pumped at the same bandwidth that it emits at.

More specifically, system 1400 may include six 100 watt thulium (Tm)-doped fiber lasers 1402 operating at 1850 nm each including an output 1402A, a first seed laser 1404 operating at 1900 nm including an output 1404A, a first pump source beam combiner 1406 having an output 1406A and including, at least in part, a first stepped cladding fiber link 1408, a first thulium-doped fiber amplifier 1410, six 540 watt lasers 1412 operating at 1900 nm each including an output 1412A, a second seed laser 1414 operating at 1950 nm including an output 1414A, a second pump source beam combiner 1416 having an output 1416A and including, at least in part, a second stepped cladding fiber link 1418, a second thulium-doped fiber amplifier 1420, six 2.9 kW lasers 1422 operating at 1900 nm each including an output 1422A, a third seed laser 1424 operating in the range of 2000-2100 nm including an output 1424A, a third pump source beam combiner 1426 having an output 1426A and including, at least in part, a third stepped cladding fiber link 1428, a thulium/holmium-doped fiber amplifier 1430 and a final output 1432.

A seed laser may be used as an energy source for amplification purposes, in that the seed energy is used to stimulate emission from an amplifier at the seed wavelength (frequency). The total amount of seed energy (number of photons) directly relates to the amount of output energy which can be extracted from the amplifier. This energy level may be called the seed intensity.

As depicted in FIG. 14, the outputs 1402A of the six 100 watt thulium (Tm)-doped fiber lasers 1402 operating at 1850 nm and the first seed laser 1404 operating at 1900 nm are fed into the first pump source beam combiner 1406 which includes, at least in part, the first stepped cladding fiber link 1408. The outputs 1406A are equal to 600 watts operating at 1850 nm. The outputs 1406A from the first pump source beam combiner 1406 pump the first thulium-doped fiber amplifier 1410 which outputs the six 540 watt lasers 1412 operating at 1900 nm. Therefore, the first seed laser 1404 operating at 1900 nm has been amplified at 90% efficiency.

The outputs 1412A of the six 540 watt lasers 1412 operating at 1900 nm and the second seed laser 1414 operating at 1950 nm are fed into the second pump source beam combiner 1416 which includes, at least in part, the second stepped cladding fiber link 1418. The outputs 1416A are equal to 3.2 kW operating at 1900 nm. The outputs 1416A from the second pump source beam combiner 1416 pump the second thulium-doped fiber amplifier 1420 which outputs the six 2.9 kW watt lasers 1422 operating at 1950 nm. Therefore, the second seed laser 1414 operating at 1950 nm has been amplified at 90% efficiency.

The outputs 1422A of the six 2.9 kW lasers 1422 operating at 1950 nm and the third seed laser 1424 operating in the range of 2000-2100 nm are fed into the third pump source beam combiner 1426 which includes, at least in part, the third stepped cladding fiber link 1428. The outputs 1426A are equal to 18.3 kW operating at 1950 nm. The outputs 1426A from the third pump source beam combiner 1426 pump the thulium/holmium-doped fiber amplifier 1430 which provides the output 1432 which is equal to 15.5 kW operating in the range of 200-2100 nm. Therefore, third seed laser 1424 operating in the range of 2000-2100 nm has been amplified at 90% efficiency.

Thus, the system 1400 provides a two micron tandem-resonated-pumped fiber laser which may produce over 10 kW of power. The recursive cascaded combination architecture conserves brightness while power scaling. The thulium/holmium amplifier provides greater than three times the bandwidth for tandem-resonated-pumping compared to a one micron fiber laser. The total power increases linearly with pump source power scaling without changing the architecture of the system 1400. Further, the geometry of the gain fibers in all of the stages is the same, and, therefore, the same pump source beam combiner may be used at each stage instead of having to change the diameters of the fibers. It is envisioned that the teachings of the present disclosure may be utilized with any suitable architecture.

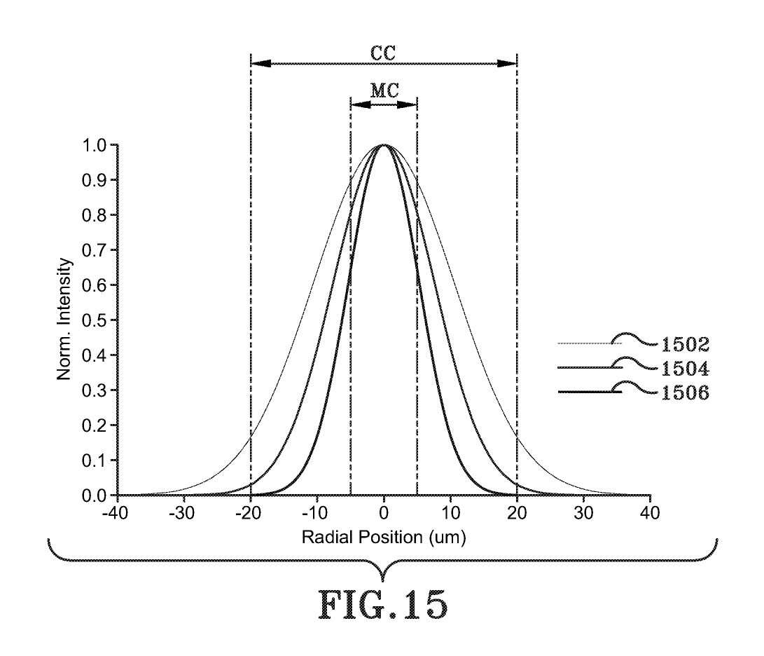

FIG. 15 is a graph depicting a Gaussian beam profile representing mode field diameters for a fiber laser 1502 tapered from a 20/80, 0.08 NA to a 10/40, 0.08 NA, a fiber laser 1504 tapered from a 20/80, 0.1 NA to a 10/40, 0.1 NA and a fiber laser 1506 tapered from a 20/80, 0.15 NA to a 10/40, 0.15 NA. Thus, the fiber lasers 1502, 1504 and 1506 underwent a 2:1 tapering ratio. Since tapering produces loss, it is beneficial to select suitable tapering ratios and fiber geometries which reduce the amount of tapering that is necessary.

As shown in FIG. 15, the y-axis is normalized intensity and the x-axis is radial position in micrometers. The dotted lines denoted as “MC” illustrate the dimensions of the ten micron core of each of the fiber lasers 1502, 1504 and 1506, and the dotted lines denoted as “CC” illustrate the dimensions of the forty micron cladding of each of the fiber lasers 1502, 1504, and 1506.

As shown in FIG. 15, the mode field diameters of the fiber lasers 1502, 1504 and 1506 change as a function of core size as well as starting NA. FIG. 15 shows how much of the Gaussian beam profile of each of the fiber lasers 1502, 1504 and 1506 is captured by the area within the MC dimensions which is directly related to how much power is actually carried by the fiber lasers 1502, 1504 and 1506.

As shown in FIG. 15, the fiber laser 1506 having a 0.15 NA carries the most power out of the three fiber lasers 1502, 1504 and 1506. The graph of FIG. 15 illustrates, at least in part, the importance of selecting suitable taper ratios and fiber geometries.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

Additionally, the method of performing the present disclosure may occur in a sequence different than those described herein. Accordingly, no sequence of the method should be read as a limitation unless explicitly stated. It is recognizable that performing some of the steps of the method in an different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A fiber optic cable comprising:
a first end and a second end;
a core adapted to receive and transmit an optical signal;
a cladding layer surrounding the core; and
a ratio of an outside diameter of the cladding layer to a diameter of the core that decreases from the first end to the second end; wherein the diameter of the core remains substantially uniform.

2. The fiber optic cable of claim 1, further comprising:
a first portion of the cladding layer; and
a second portion of the cladding layer; wherein a uniform outside diameter of the second portion is less than a uniform outside diameter of the first portion.

3. The fiber optic cable of claim 2, wherein a ratio of the uniform outside diameter of the first portion to the uniform outside diameter of the second portion is at most approximately 2:1.

4. The fiber optic cable of claim 2, further comprising:
a first end wall and a second end wall of the first portion of the cladding layer;
a first end wall and a second end wall of the second portion of the cladding layer; and
an exposed area of the second end wall of the first portion of the cladding layer formed when the second end wall of the first portion of the cladding layer is connected to the first end wall of the second portion of the cladding layer.

5. The fiber optic cable of claim 4, wherein the second end wall of the first portion of the cladding layer is connected to the first end wall of the second portion of the cladding layer by splicing.

6. The fiber optic cable of claim 2, further comprising:
a third portion of the cladding layer; wherein a uniform outside diameter of the third portion is less than a uniform outside diameter of the second portion.

7. The fiber optic cable of claim 6, wherein a ratio of the uniform outside diameter of the second portion to the uniform outside diameter of the third portion is at most approximately 2:1.

8. The fiber optic cable of claim 6, further comprising:
a first end wall and a second end wall of the third portion of the cladding layer; and
an exposed area of the second end wall of the second portion of the cladding layer formed when the second end wall of the second portion of the cladding layer is connected to the first end wall of the third portion of the cladding layer.

9. The fiber optic cable of claim 6, wherein the second end wall of the second portion of the cladding layer is connected to the first end wall of the third portion of the cladding layer by splicing.

10. The fiber optic cable of claim 6 connected to a high-density tapered fiber bundle.

11. The fiber optic cable of claim 10 connected to a triple clad fiber.

12. The fiber optic cable of claim 11 connected to at least one input fiber laser, at least one seed laser, at least one thulium-doped amplifier and an output laser source.

13. The fiber laser of claim 12 connected to a thulium/holmium-doped amplifier.

14. A fiber laser comprising:
a first cladded optical fiber including a uniform first outer diameter along its length connected to a pump laser; and
a second cladded optical fiber including a uniform second outer diameter along its length connected to the first cladded optical fiber so as to allow an optical signal to move from the first cladded optical fiber through the second cladded optical fiber; wherein the uniform second outer diameter is less than the uniform first outer diameter.

15. The fiber laser of claim 14, further comprising:
a third cladded optical fiber including a uniform third outer diameter along its length connected to the second cladded optical fiber; wherein the uniform third outer diameter is less than the uniform second outer diameter.

16. The fiber laser of claim 15, further comprising:
a first core diameter of the first cladded optical fiber;
a second core diameter of the second cladded optical fiber; and
a third core diameter of the third cladded optical fiber; wherein the first core diameter, the second core diameter and the third core diameter are substantially equal.

17. The fiber laser of claim 15, further comprising:
a fourth cladded optical fiber including a distal end coupled to a combiner having a decreasing tapered outer cladding diameter and a decreasing tapered core diameter.

18. The fiber laser of claim 15, further comprising:
a length of each of the cladded optical fibers; wherein each length of each of the cladded optical fibers is substantially equivalent.

19. The fiber laser of claim 15, further comprising:
a high-density tapered fiber bundle.

20. The fiber laser of claim 19, further comprising:
a triple clad fiber.
